(19) United States
(12) Patent Application Publication
(10) Pub. No.: US 2015/0032284 A1
(43) Pub. Date: Jan. 29, 2015

(54) DETECTION MODULE, DEVICE AND SYSTEM FOR DETECTING FAN'S CONNECTION AND DISCONNECTION STATES

(71) Applicant: ASIA VITAL COMPONENTS CO., LTD., New Taipei City (TW)

(72) Inventors: Peng-An Chen, New Taipei City (TW); Sung-Hsiang Tsang, New Taipei City (TW); Dong-Qi Tian, New Taipei City (TW)

(73) Assignee: ASIA VITAL COMPONENTS CO., LTD., New Taipei City (TW)

(21) Appl. No.: 13/953,716

(22) Filed: Jul. 29, 2013

(51) Int. Cl. G05D 23/19

(52) U.S. Cl. CPC G05D 23/19
USPC 700/300

(57) ABSTRACT

A detection system for detecting fan's connection and disconnection states includes a detection module connected to a fan and a host. The fan has four external connection terminals for connecting to the detection module. Two of the four external connection terminals are a rotation speed control terminal, via which a detection signal and a rotation speed control signal are transmitted from the detection module to the fan, and a rotation speed feedback terminal, via which a fed back detection signal and a fan rotation speed signal are transmitted from the fan to the detection module. The host determines whether the fan is connected to or disconnected from the detection module according to whether or not a fed back detection signal is received by the detection module from the fan.

### FIELD OF THE INVENTION

The present invention relates to a detection module, device and system for detecting fan's connection and disconnection states; and more particularly, to a detection module, device and system for detecting whether a fan is connected to a control circuit board.

### BACKGROUND OF THE INVENTION

Generally, a computer room has a large number of computers housed therein. These computers produce a high amount of heat during operation thereof. For the computers to operate in an environment having a constant temperature condition, fans are mounted in the computer room to remove the computer produced heat from the computer room. Usually, a control circuit board and a plurality of fans connected thereto together constitute a fan module.

Since the computer room is generally staffless and adopts closed-off management, the control circuit board of the fan module is connected to a remote server apparatus, so that the connection state and the operation state of the fans can be monitored and determined from the remote server apparatus.

Most of the currently available fans are provided with four external connection terminals. FIG. 1 is a block diagram of a fan module being currently used to achieve the purpose of remotely monitoring the fans in a computer room. As shown, the fan module includes a control circuit board 10, to which at least one fan 17 is connected. The control circuit board 10 includes a power supply unit 11 and a processor unit 12 connected to the power supply unit 11. The power supply unit 11 is connected to an external power supply and supplies the power to the processor unit 12 and the at least one fan 17 for them to operate. The processor unit 12 is able to generate a fan rotation speed control signal, which can be, for example, a pulse width modulation (PWM) signal, to the fan 17 via a fan rotation speed driving circuit 14 for driving the fan 17 to operate and controlling the fan's rotation speed. On the other hand, the fan 17, during operation thereof, is able to generate a fan rotation speed signal (FG) to the processor unit 12 via a fan rotation speed feedback circuit 15. The processor unit 12 is further connected to a connection state detection unit 13 for receiving a connection signal from the fan 17.

Therefore, the fan 17 used with the control circuit board 10 has total five external connection terminals, namely, a positive power terminal 171, a negative power terminal 172, a connection signal terminal 173, a rotation speed control input terminal 174 and a fan rotation speed feedback terminal 175. The positive and the negative power terminal 171, 172 are respectively connected to a positive and a negative power output terminal of the power supply unit 11 for receiving power supply from the power supply unit 11. The connection signal terminal 173 is connected to the connection state detection unit 13 of the control circuit board 10. The rotation speed control signal generated by the processor unit 12 of the control circuit board 10 is transmitted to the fan 17 via the rotation speed control input terminal 174. When being driven by the rotation speed control signal to operate, the fan 17 correspondingly generates the fan rotation speed signal (FG) during operation thereof for feeding back to the processor unit 12 of the control circuit board 10 via the fan rotation speed feedback terminal 175.

The connection state detection unit 13 of the control circuit board 10 can be, for example, a pull-up resistor or an optically coupled isolation circuit; and the connection signal terminal 173 electrically connected to the connection state detection unit 13 is grounded or connected to a high-level signal. In FIG. 1, the connection signal terminal 173 is grounded at the fan side, and the connection state detection unit 13 is a pull-up resistor for generating a high-level connection signal.

Please refer to FIGS. 2A to 2C. When the fan 17 is not connected to the control circuit board 10, the connection signal generated by the connection state detection unit 13, such as a pull-up resistor, is a high-level signal (HS), and the connection signal received by the processor unit 12 is high, as shown in FIG. 2A. On the other hand, when the fan 17 is connected to the control circuit board 10, the connection state detection unit 13 is connected to the fan 17 via the connection signal terminal 173 and is further grounded, so that the high-level connection signal (HS) generated by the connection state detection unit 13 flows to ground, and the connection signal received by the processor unit 12 from the connection state detection unit 13 changes from high to low (LS), as shown in FIG. 2B. Alternatively, when the fan 17 is removed, i.e. when the fan 17 is disconnected from the control circuit board 10, the connection signal received by the processor unit 12 from the connection state detection unit 13 changes from low (LS) to high (HS) again, as shown in FIG. 2C.

According to the high level or the low level of the connection signal received at the pin of the processor unit 12 that is connected to the connection state detection unit 13, the remote server apparatus determines whether the fan 17 is connected to the control circuit board 10 or not.

The above-described conventional fan module is disadvantageous because the processor unit 12 requires an additional pin for receiving the connection signal, the control circuit board 10 must include an additional detection unit, and the fan 17 also has to increase an additional external connection terminal, namely, the connection signal terminal 173. For the control circuit board 10, it must have increased wiring space in response to the additional pin of the processor unit 12 and the additional detection unit. Further, the increased pin and detection unit inevitably results in complicated manufacturing process and expanded area of the control circuit board. Similarly, the additional external connection terminal on the fan also results in more complicated manufacturing process of the fan. All these factors in turn result in increased cost and product volume of the fan module.

### SUMMARY OF THE INVENTION

A primary object of the present invention is to provide a fan detection design that utilizes two existing external connection terminals of a fan, i.e. a rotation speed control terminal and a rotation speed feedback terminal, to detect the fan's connection signal. This design is applicable to a conventional fan but saves one external connection terminal from the fan.

Another object of the present invention is to provide a fan detection design that omits the connection state detection unit from a detection module, so that the required wiring spaces in the detection module and the fan connected thereto are reduced to enable simplified manufacturing process and decreased volume of the detection module and of the fan.

To achieve the above and other objects, in one aspect of the present invention, a detection module for detecting at least one fan's connection and disconnection states is provided. The fan has a positive power terminal, a negative power terminal, a rotation speed control terminal and a rotation speed feedback terminal, and generates a fan rotation speed signal during operation thereof. The detection module includes a power supply unit and a processor unit. The power supply unit is connected to the positive and the negative power terminal of the fan, so as to provide an external power supply to the fan via the positive and the negative power terminal. The processor unit is connected to the power supply unit and generates a detection signal and a rotation speed control signal to the fan via the rotation speed control terminal. The rotation speed control signal drives the fan to operate and accordingly generate the fan rotation speed signal to the processor unit via the rotation speed feedback terminal. The detection signal is also fed back from the fan to the processor unit via the rotation speed feedback terminal. With these arrangements, the detection module determines whether the fan is connected thereto according to whether or not a fed back detection signal is received by the processor unit from the fan.

In another aspect of the present invention, a detection device for detecting fan's connection and disconnection states is provided. The detection device includes a fan having a positive power terminal, a negative power terminal, a rotation speed control terminal and a rotation speed feedback terminal; and a detection module including a power supply unit and a processor unit. The power supply unit is connected to the positive and the negative power terminal of the fan, so as to provide an external power supply to the fan via the positive and the negative power terminal. The processor unit is connected to the power supply unit and generates a detection signal and a rotation speed control signal to the fan via the rotation speed control terminal. The rotation speed control signal drives the fan to operate and accordingly generate a fan rotation speed signal to the processor unit via the rotation speed feedback terminal. The detection signal is also fed back from the fan to the processor unit via the rotation speed feedback terminal. With these arrangements, the detection device determines whether the fan is connected to the detection module according to whether or not a fed back detection signal is received by the processor unit from the fan.

In a further aspect of the present invention, a detection system for detecting fan's connection and disconnection states is provided. The detection system includes a fan having a positive power terminal, a negative power terminal, a rotation speed control terminal and a rotation speed feedback terminal; a detection module including a power supply unit and a processor unit; and a host connected to the detection module via a communication connection unit. The power supply unit is connected to the positive and the negative power terminal of the fan, so as to provide an external power supply to the fan via the positive and the negative power terminal. The processor unit is connected to the power supply unit and generates a detection signal and a rotation speed control signal to the fan via the rotation speed control terminal. The rotation speed control signal drives the fan to operate and accordingly generate a fan rotation speed signal to the processor unit via the rotation speed feedback terminal. The detection signal is also fed back from the fan to the processor unit via the rotation speed feedback terminal. With these arrangements, the host of the detection system determines whether the fan is connected to the detection module according to whether or not a fed back detection signal is received by the processor unit from the fan and then transmitted to the host via the communication connection unit.

The power supply unit is connected to an external power supply. The detection device further includes a connection interface, to which the positive power terminal, the negative power terminal, the rotation speed control terminal and the rotation speed feedback terminal of the fan are connected. The processor unit first transmits the detection signal to the fan before the power supply unit provides the external power supply to the fan. Then, the processor unit also transmits the detection signal to the fan when the fan rotation speed signal generated by the fan to the processor unit has a value of zero. In the present invention, the detection signal has a frequency and a mark-space ratio different from those of the rotation speed control signal.

According to the present invention, the host of the detection system determines whether the fan is connected to the detection module according to whether or not a fed back detection signal is received by the processor unit from the fan and then transmitted to the host via the communication connection unit.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional fan module;

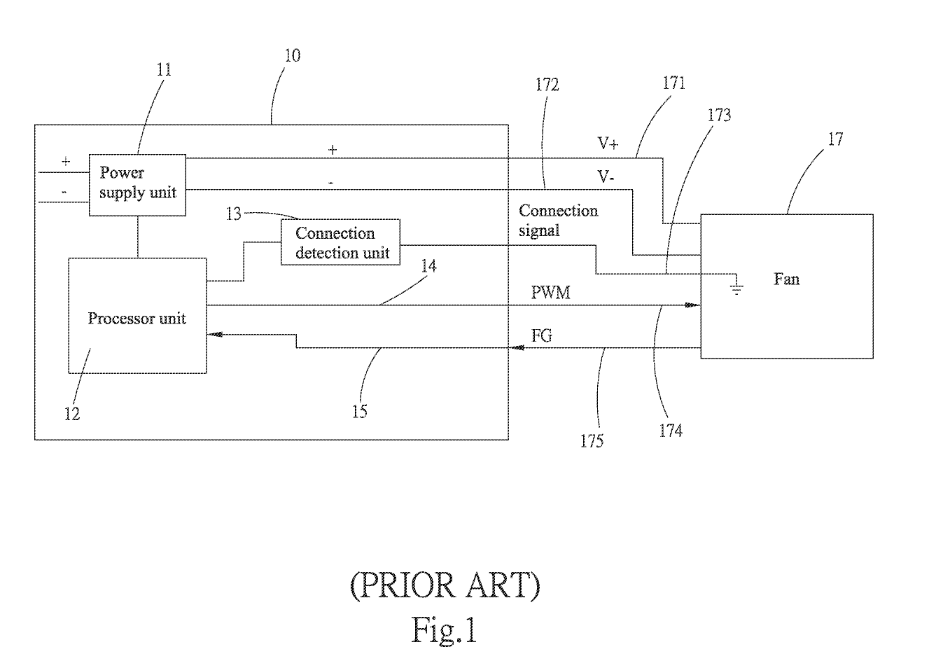

FIG. 2A is a graph showing a connection signal that indicates a fan in the conventional fan module of FIG. 1 is not connected to a control circuit board of the fan module;

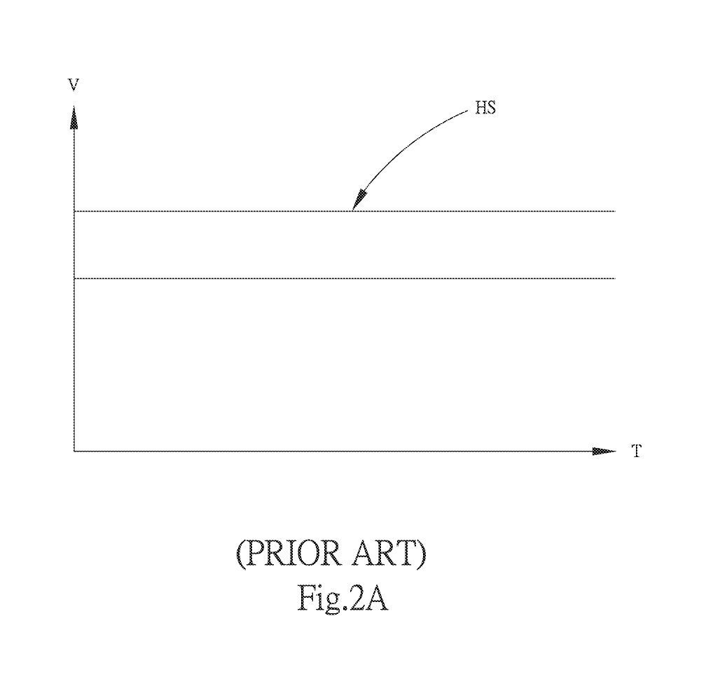

FIG. 2B is a graph showing a connection signal that changes from a high level to a low level to indicate a disconnected fan in the conventional fan module of FIG. 1 is then connected to the control circuit board of the fan module again;

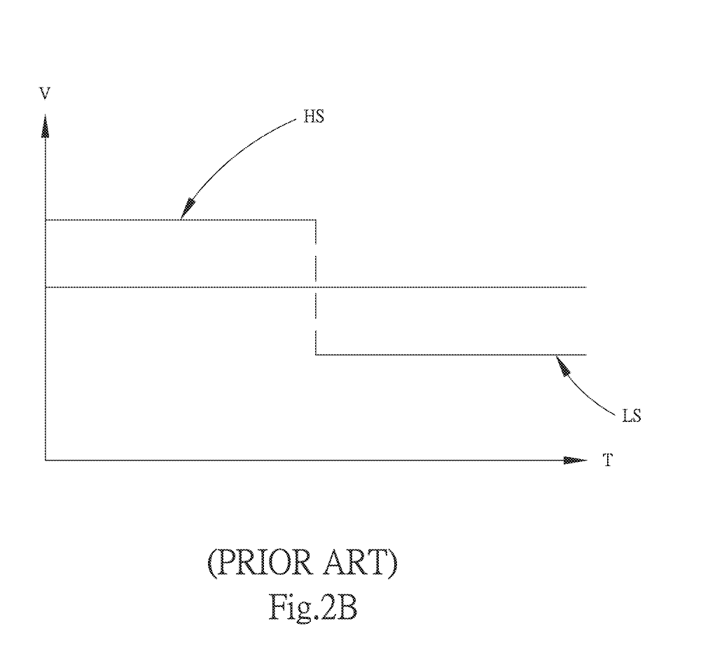

FIG. 2C is a graph showing a connection signal that changes from a low level to a high level to indicate a connected fan in the conventional fan module of FIG. 1 is then disconnected from the control circuit board of the fan module again;

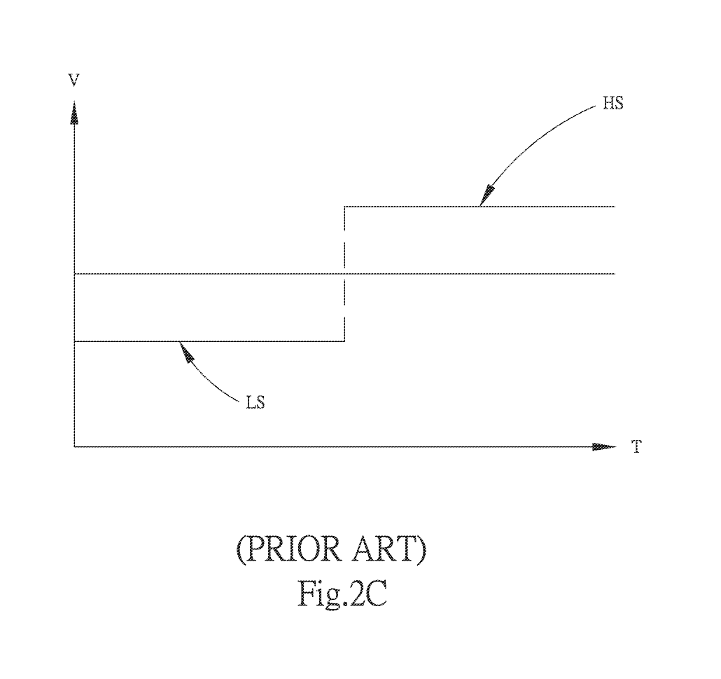

FIG. 3 is a block diagram of a detection device according to the present invention;

FIG. 4 is a block diagram of a detection system according to the present invention;

FIG. 5 is a graph showing a detection signal and a fed back detection signal that indicates a fan is not connected to a detection module of the detection device of FIG. 3 or of the detection system of FIG. 4;

FIG. 6 is a graph showing a detection signal and a fed back detection signal that indicates a fan is connected to the detection module of the detection device of FIG. 3 or of the detection system of FIG. 4;

FIG. 7 is a graph showing a rotation speed control signal and a fed back fan rotation speed signal that indicates a fan is connected to the detection module of the detection device of FIG. 3 or of the detection system of FIG. 4; and

FIG. 8 is a graph showing a detection signal and a fed back fan rotation speed signal that indicate a connected fan has been disconnected from the detection module of the detection device of FIG. 3 or of the detection system of FIG. 4.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

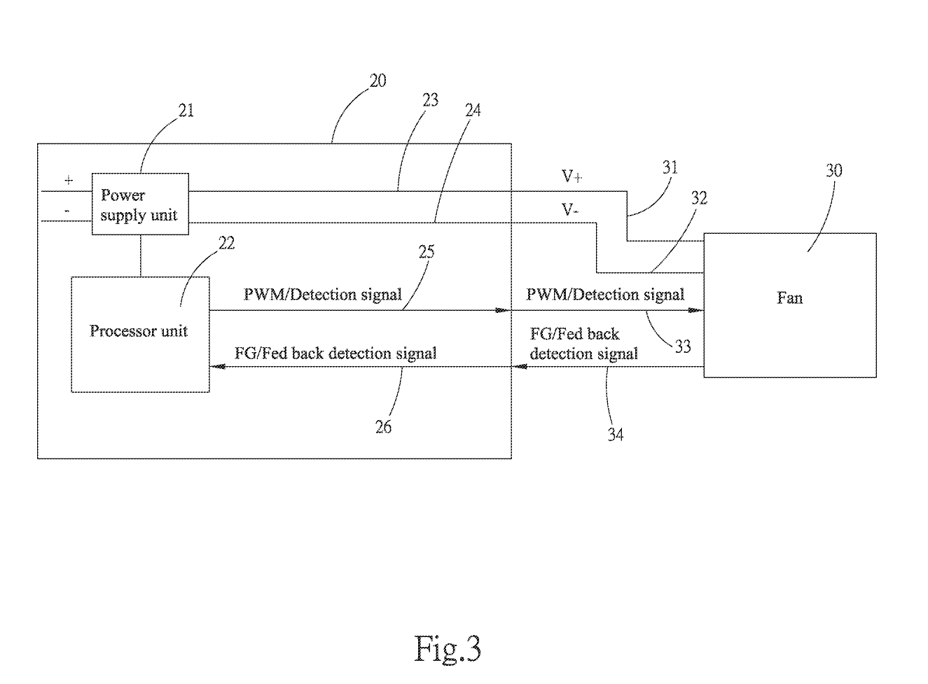

Please refer to FIG. 3 that is a block diagram of a detection device according to a preferred embodiment of the present invention. As shown, the detection device includes a detection module 20 having at least one fan 30 connected thereto. The fan 30 has a positive power terminal 31, a negative power terminal 32, a rotation speed control terminal 33, and a rotation speed feedback terminal 34. Via the positive power terminal 31 and the negative power terminal 32, electric power is supplied to the fan 30 for the same to operate. Via the rotation speed control terminal 33, a rotation speed control signal is input to the fan 30 for driving the fan 30 to rotate and controlling the fan's rotation speed. Via the rotation speed feedback terminal 34, a fan rotation speed signal generated by the fan 30 during actual operation thereof is output to the detection module 20.

The detection module 20 includes a power supply unit 21 and a processor unit 22, and can be, for example, a control circuit board. The power supply unit 21 receives an external power supply, and is connected via a positive power circuit 23 and a negative power circuit 24 to the positive power terminal 31 and the negative power terminal 32 of the fan 30, respectively, such that the received external power supply is supplied to the fan 30 via the positive and the negative power terminal 31, 32. Generally, the fan used with a heat-producing electronic product has a power supply of 12V. The processor unit 22 is connected with the power supply unit 21, and is used to generate a detection signal and the above-mentioned rotation speed control signal to the fan 30 via the rotation speed control terminal 33. On the other hand, the above-mentioned fan rotation speed signal and the detection signal are returned from the fan 30 to the processor unit 22 via the rotation speed feedback terminal 34.

More specifically, the processor unit 22 is connected via a driving circuit 25 to the rotation speed control terminal 33 of the fan 30, and is connected via a rotation speed detection circuit 26 to the rotation speed feedback terminal 34 of the fan 30. Therefore, the rotation speed control signal and the detection signal are sent to the fan 30 via the driving circuit 25 and the rotation speed control terminal 33; and the fan rotation speed signal and the fed back detection signal are sent from the rotation speed feedback terminal 34 to the processor unit 22 via the rotation speed detection circuit 26. According to an embodiment of the present invention, the processor unit 22 can be, for example, a microcontroller unit (MCU).

Particularly, the detection signal is sent by the processor unit 22 to the fan 30 either before the fan 30 receives the power supply from the power supply unit 21 or when a value of the fan rotation speed signal received by the processor unit 22 is zero, i.e. when the processor unit 22 does not receive the fan rotation speed signal from the fan 30, so as to detect whether the fan 30 is connected to the detection module 20 or not. The detection signal generated by the processor unit 22 would not be fed back from the rotation speed feedback terminal 34 of the fan 30 to the processor unit 22 when the fan 30 is not connected to the detection module 20 or any one of the positive power terminal 31, the negative power terminal 32, the rotation speed control terminal 33 and the rotation speed feedback terminal 34 of the fan 30 is not connected to the detection module 20.

In the present invention, the rotation speed control signal is a pulse width modulation (PWM) signal, and the detection signal is a signal having a frequency and a mark-space ratio different from those of the PWM signal of the rotation speed control signal.

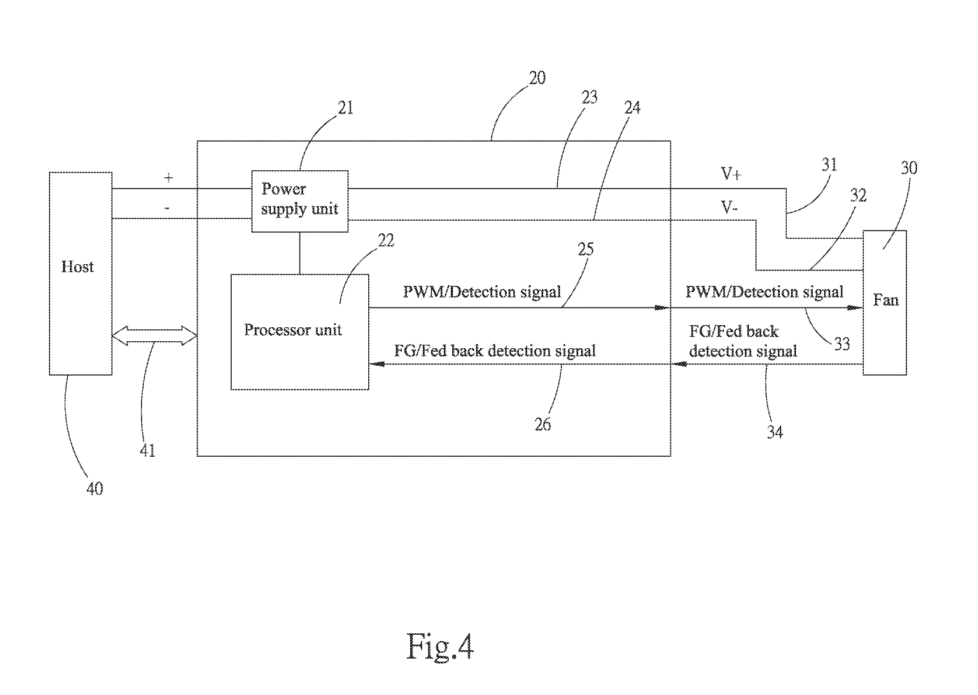

FIG. 4 is a block diagram of a detection system according to a preferred embodiment of the present invention. In practice, the detection module 20 and the fan 30 are mounted in a place where heat dissipation is needed, such as a computer room. A host 40 at a remote location is connected to the detection module 20 via a communication connection unit 41, which can be a bus, for example. The external power supply received by the power supply unit 21 is provided by the host 40. The rotation speed control signal and the detection signal generated by the processor unit 22 as well as the fan rotation speed signal and the fed back detection signal all are sent to the host 40 via the communication connection unit 41. Therefore, the host 40 can determine the connection state between the fan 30 and the detection module 20 based on whether the detection signal is fed back from the fan 30 and received by the processor unit 22.

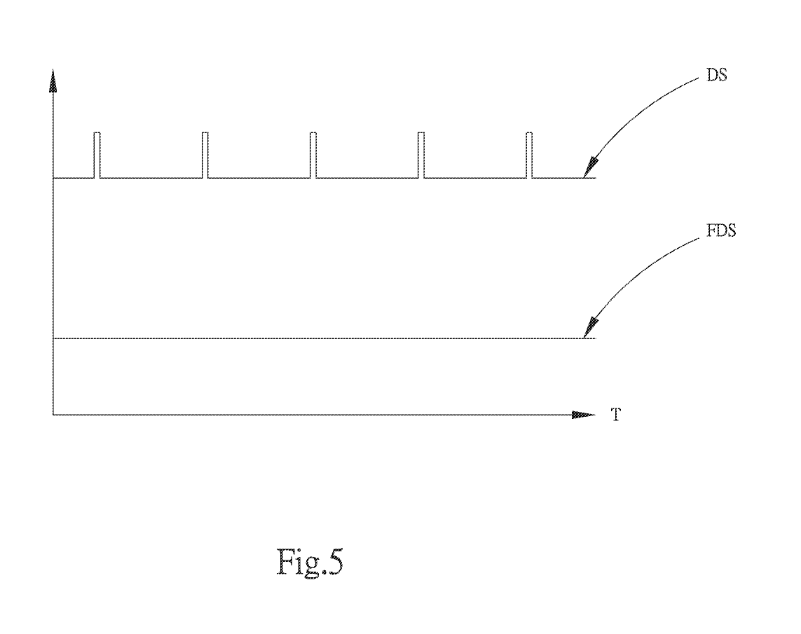

How the connection state between the detection module 20 and the fan 30 can be determined is now described with reference to FIGS. 5 to 8. Herein, the fan rotation speed signal is a PWM signal having a frequency of 10 KHz and a mark-space ratio of 50%; and the detection signal is also a PWM signal but having a frequency of 1 KHz and a mark-space ratio of 5%.

As shown in FIG. 5, the processor unit 22 of the detection module 20 first transmits a detection signal (DS) to the fan 30 via the rotation speed control terminal 33. However, the processor unit 22 does not receive any fed back detection signal (FDS) from the rotation speed feedback terminal 34 of the fan 30, and in FIG. 5, it is shown the fed back detection signal (FDS) is zero. Therefore, it is determined the fan 30 is not connected to the detection module 20, or any one of the positive power terminal 31, the negative power terminal 32, the rotation speed control terminal 33 and the rotation speed feedback terminal 34 of the fan 30 is not connected to the detection module 20.

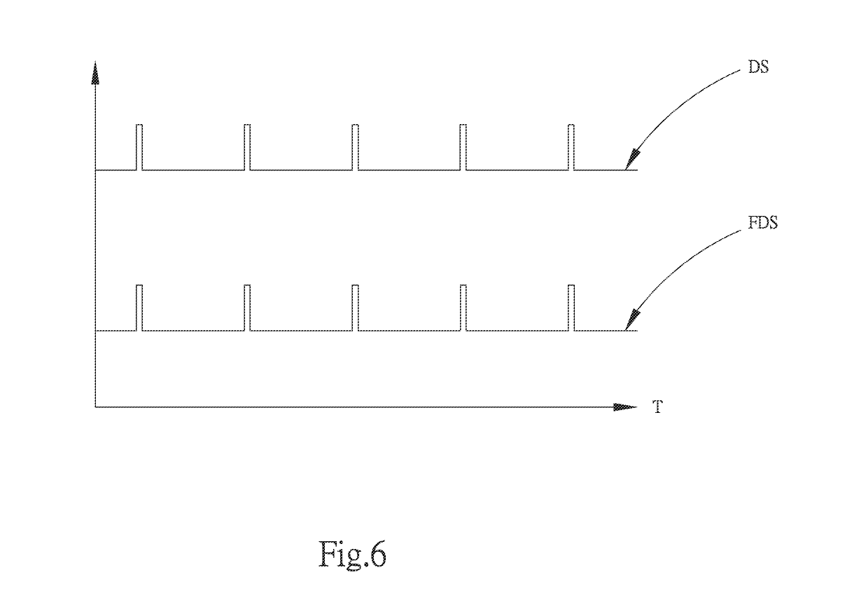

As shown in FIG. 6, the processor unit 22 of the detection module 20 first transmits a detection signal (DS) to the fan 30 via the rotation speed control terminal 33; and then the processor unit 22 receives a fed back detection signal (FDS) from the rotation speed feedback terminal 34 of the fan 30. Therefore, it is determined the fan 30 is connected to the detection module 20.

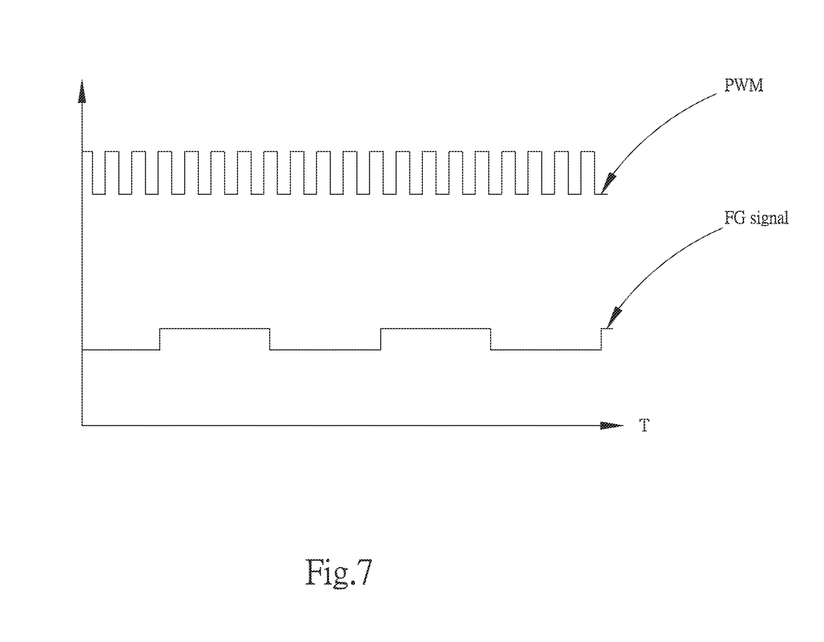

Please refer to FIG. 7. When it is detected that the fan 30 is connected to the detection module 20, the processor unit 22 then transmits a rotation speed control signal (PWM) to the fan 30 via the rotation speed control terminal 33 for driving the fan 30 to operate. The fan 30 in operating correspondingly generates a fan rotation speed signal (FG) to the detection module 20 via the rotation speed feedback terminal 34.

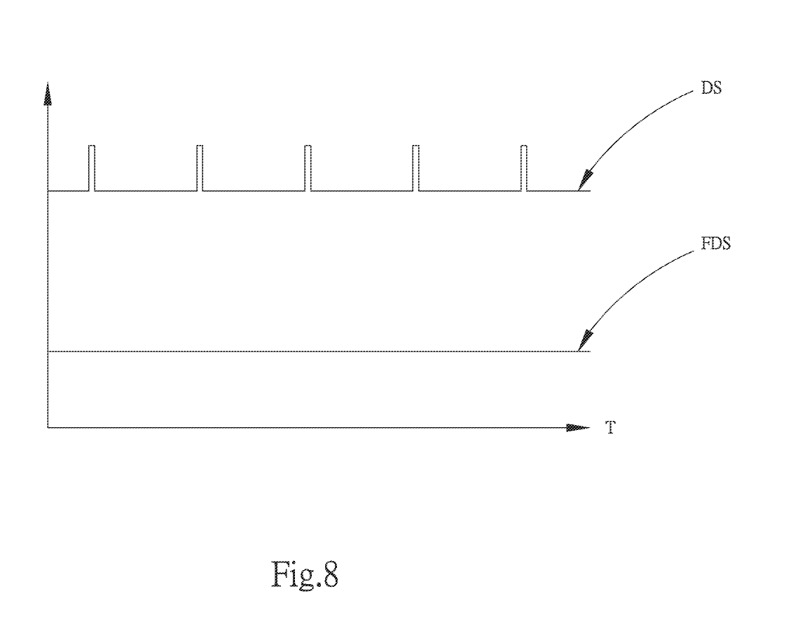

Please refer to FIG. 8. In the case the fan 30 is removed from the detection device of FIG. 3 or the detection system of FIG. 4, the fan 30 is no longer connected to the detection module and no fan rotation speed signal (FG) is received by the processor unit 22 via the rotation speed feedback terminal 34, i.e. the fan rotation speed signal (FG) is zero. At this point, the processor unit 22 will transmit a detection signal (DS) again to the fan 30 via the rotation speed control terminal 33. When the processor unit 22 does not receive a fed back detection signal (FDS) from the fan 30 via the rotation speed feedback terminal 34, that is, the fed back detection signal is zero as shown in FIG. 8, it is determined the fan 30 is not connected to the detection module 20.

As can be found from the above description, in the present invention, two existing external connection terminals of the fan, i.e. the rotation speed control terminal and the rotation speed feedback terminal, are directly used to detect the fan's connection signal. This design is applicable to a conventional fan but saves one external connection terminal from the fan and omits the connection state detection unit from the control circuit board. With the present invention, the required wiring spaces in the control circuit board and the fan are reduced to enable simplified manufacturing process and decreased volume of the control circuit board and of the fan.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A detection module for detecting fan's connection and disconnection states, being adapted to detect at least one fan, which has a positive power terminal, a negative power terminal, a rotation speed control terminal and a rotation speed feedback terminal and generates a fan rotation speed signal during operation thereof, comprising:
a power supply unit for receiving an external power supply; the power supply unit being connected to the positive power terminal and the negative power terminal of the fan, and providing the external power supply to the fan via the positive power terminal and the negative power terminal; and
a processor unit being connected to the power supply unit and capable of generating a detection signal and a rotation speed control signal to the fan via the rotation speed control terminal; the rotation speed control signal driving the fan to operate and accordingly generate the fan rotation speed signal, which is transmitted to the processor unit via the rotation speed feedback terminal of the fan; and the detection signal transmitted to the fan being fed back to the processor unit via the rotation speed feedback terminal of the fan;
whereby the processor unit determines whether the fan is connected to or disconnected from the detection module according to whether or not a fed back detection signal is received by the processor unit from the fan.

2. The detection module for detecting fan's connection and disconnection states as claimed in claim 1, wherein the processor unit transmits the detection signal to the fan before the power supply unit provides the external power supply to the fan.

3. The detection module for detecting fan's connection and disconnection states as claimed in claim 1, wherein the processor unit transmits the detection signal to the fan when the fan rotation speed signal received by the processor unit has a value of zero.

4. The detection module for detecting fan's connection and disconnection states as claimed in claim 1, wherein the detection signal has a frequency and a mark-space ratio different from those of the rotation speed control signal.

5. The detection module for detecting fan's connection and disconnection states as claimed in claim 1, wherein the processor unit is connected to the fan's rotation speed control terminal via a driving circuit, and to the fan's rotation speed feedback terminal via a rotation speed detection circuit.

6. A detection device for detecting fan's connection and disconnection states, comprising:
a fan having a positive power terminal, a negative power terminal, a rotation speed control terminal, and a rotation speed feedback terminal; and
a detection module including:
a power supply unit for receiving an external power supply; the power supply unit being connected to the positive power terminal and the negative power terminal of the fan, and providing the external power supply to the fan via the positive power terminal and the negative power terminal; and
a processor unit being connected to the power supply unit and capable of generating a detection signal and a rotation speed control signal to the fan via the rotation speed control terminal; the rotation speed control signal driving the fan to operate and accordingly generate a fan rotation speed signal, which is transmitted to the processor unit via the rotation speed feedback terminal of the fan; and the detection signal transmitted to the fan being fed back to the processor unit via the rotation speed feedback terminal of the fan;
whereby the processor unit determines whether the fan is connected to or disconnected from the detection module according to whether or not a fed back detection signal is received by the processor unit from the fan.

7. The detection device for detecting fan's connection and disconnection states as claimed in claim 6, wherein the processor unit transmits the detection signal to the fan before the power supply unit provides the external power supply to the fan.

8. The detection device for detecting fan's connection and disconnection states as claimed in claim 6, wherein the processor unit transmits the detection signal to the fan when the fan rotation speed signal received by the processor unit has a value of zero.

9. The detection device for detecting fan's connection and disconnection states as claimed in claim 6, wherein the detection signal has a frequency and a mark-space ratio different from those of the rotation speed control signal.

10. The detection device for detecting fan's connection and disconnection states as claimed in claim 6, wherein the processor unit is connected to the fan's rotation speed control terminal via a driving circuit, and to the fan's rotation speed feedback terminal via a rotation speed detection circuit.

11. A detection system for detecting fan's connection and disconnection states, comprising:
a fan having a positive power terminal, a negative power terminal, a rotation speed control terminal, and a rotation speed feedback terminal;
a detection module including:
a power supply unit for receiving an external power supply; the power supply unit being connected to the positive power terminal and the negative power terminal of the fan, and providing the external power supply to the fan via the positive power terminal and the negative power terminal; and
a processor unit being connected to the power supply unit and capable of generating a detection signal and a rotation speed control signal to the fan via the rotation speed control terminal; the rotation speed control signal driving the fan to operate and accordingly generate a fan rotation speed signal, which is transmitted to the processor unit via the rotation speed feedback terminal of the fan; and the detection signal transmitted to the fan being fed back to the processor unit via the rotation speed feedback terminal of the fan; and
a host being connected to the detection module via a communication connection unit, and determining whether the fan is connected to or disconnected from the detection module according to whether or not a fed back detection signal is received by the processor unit from the fan and transmitted to the host via the communication connection unit.

12. The detection system for detecting fan's connection and disconnection states as claimed in claim 11, wherein the external power supply is provided by the host.

13. The detection system for detecting fan's connection and disconnection states as claimed in claim 11, wherein the processor unit transmits the detection signal to the fan before the power supply unit provides the external power supply to the fan.

14. The detection system for detecting fan's connection and disconnection states as claimed in claim 11, wherein the processor unit transmits the detection signal to the fan when the fan rotation speed signal received by the processor unit has a value of zero.

15. The detection system for detecting fan's connection and disconnection states as claimed in claim 11, wherein the detection signal has a frequency and a mark-space ratio different from those of the rotation speed control signal.

16. The detection system for detecting fan's connection and disconnection states as claimed in claim 11, wherein the processor unit is connected to the fan's rotation speed control terminal via a driving circuit, and to the fan's rotation speed feedback terminal via a rotation speed detection circuit.
